(19) United States
(12) Patent Application Publication
(10) Pub. No.: US 2022/0374644 A1
(43) Pub. Date: Nov. 24, 2022

(54) EDGE COMPUTING-BASED CONTROL METHOD AND APPARATUS, EDGE DEVICE AND STORAGE MEDIUM

(71) Applicant: SENSETIME INTERNATIONAL PTE. LTD., Singapore (SG)

(72) Inventors: Jinliang LIN, Singapore (SG); Jiacheng Wu, Singapore (SG); Dongliang Sun, Singapore (SG); Shuai Zhang, Singapore (SG)

(21) Appl. No.: 17/361,675

(22) Filed: Jun. 29, 2021

Related U.S. Application Data
(63) Continuation of application No. PCT/IB2021/054761, filed on May 31, 2021.

(30) Foreign Application Priority Data
May 21, 2021 (SG) 10202105405Q

(51) Int. Cl. G06K 9/00; G06K 9/62; H04L 12/24; H04L 29/06; G06F 16/53

(52) U.S. Cl. CPC G06K 9/00986; G06K 9/00268; G06K 9/6202; G06K 9/00926; G06K 9/6217; G06K 9/00288; H04L 41/0668; H04L 65/605; G06F 16/53

(57) ABSTRACT

Provided are an edge computing-based control method and apparatus, an edge device and a storage medium. The method includes that: an analysis processing tool for implementing image analysis processing in a cloud server is acquired; in a case where the cloud server is in a fault state, image analysis processing is performed on a to-be-processed image with the analysis processing tool to obtain an analysis processing result; and the analysis processing result is synchronized to the cloud server.

### CROSS-REFERENCE TO RELATED APPLICATION

This is continuation application of the international application PCT/IB2021/054761, filed on 31 May 2021, which claims priority to Singapore patent application No. 10202105405Q, filed with IPOS on 21 May 2021. The contents of international application PCT/IB2021/054761 and Singapore patent application No. 10202105405Q are incorporated herein by reference in their entireties.

### TECHNICAL FIELD

The present disclosure relates to the technical field of computer vision, and more particularly, to an edge computing-based control method and apparatus, an edge device and a storage medium.

### BACKGROUND

At present, when services are processed in a real-time video processing system, most service logics are typically provided in a cloud server for execution, to maximize the utilization rate of cloud resources.

However, in a case of a fault in the cloud server, the whole video real-time processing system cannot operate normally, and the image analysis service is interrupted completely.

### SUMMARY

Embodiments of the present disclosure are intended to provide an edge computing-based control method and apparatus, an edge device and a storage medium.

The technical solutions in the embodiments of the present disclosure are implemented as follows.

The embodiments of the present disclosure provide an edge computing-based control method, which may be applied to an edge device, and include the following operations.

An analysis processing tool for implementing image analysis processing in a cloud server is acquired.

In a case where the cloud server is in a fault state, image analysis processing is performed on a to-be-processed image with the analysis processing tool to obtain an analysis processing result.

The analysis processing result is synchronized to the cloud server.

In the above method, the analysis processing tool includes a computer vision algorithmic model, and the operation that the image analysis processing is performed on the to-be-processed image with the analysis processing tool to obtain the analysis processing result includes the following operations.

Feature information extraction is performed on a target object in the to-be-processed image with the computer vision algorithmic model to obtain first feature information.

The analysis processing result is determined based on the first feature information.

In the above method, the first feature information is a first face feature, the analysis processing tool further includes a feature information library, and the operation that the analysis processing result is determined based on the first feature information includes the following operations.

A second face feature matching with the first face feature is searched from the feature information library.

Information associated with the second face feature in the feature information library is determined as the analysis processing result.

In the above method, after the analysis processing tool for implementing the image analysis processing in the cloud server is acquired, the method further includes the following operations.

In a case where the cloud server obtains feature update information, the feature update information is acquired from the cloud server.

The feature information library is updated with the feature update information.

In the above method, after the analysis processing tool for implementing the image analysis processing in the cloud server is acquired, the method further includes the following operations.

In a case where the cloud server generates a model update software package, the model update software package is acquired from the cloud server.

The computer vision algorithmic model is updated with the model update software package.

In the above method, the method further includes the following operations.

A present configuration file in the cloud server is acquired.

In a case where a configuration file of an update version is detected from the cloud server, the configuration file of the update version in the cloud server is acquired.

The present configuration file is updated to the configuration file of the upgrade version.

In the above method, the operation that the analysis processing result is synchronized to the cloud server includes the following operations.

The analysis processing result is stored.

In a case where the cloud server is converted from the fault state into a normal state, the analysis processing result is synchronized to the cloud server.

The embodiments of the present disclosure provide an edge computing-based control apparatus, which is applied to an edge device, and includes: a communication module and a processing module.

The communication module is configured to acquire an analysis processing tool for implementing image analysis processing in a cloud server.

The processing module is configured to perform, in a case where the cloud server is in a fault state, image analysis processing on a to-be-processed image with the analysis processing tool to obtain an analysis processing result.

The communication module is further configured to synchronize the analysis processing result to the cloud server.

In the above apparatus, the analysis processing tool includes a computer vision algorithmic model, and the processing module is specifically configured to: perform feature information extraction on a target object in the to-be-processed image with the computer vision algorithmic model to obtain first feature information; and determine the analysis processing result based on the first feature information.

In the above apparatus, the first feature information is a first face feature, the analysis processing tool further includes a feature information library, and the processing module is specifically configured to: search a second face feature matching with the first face feature from the feature information library; and determine information associated with the second face feature in the feature information library as the analysis processing result.

In the above apparatus, the apparatus further includes an updating module. The communication module is further configured to acquire, in a case where the cloud server obtains feature update information, the feature update information from the cloud server.

The updating module is further configured to update the feature information library with the feature update information.

In the above apparatus, the communication module is further configured to acquire, in a case where the cloud server generates a model update software package, the model update software package from the cloud server.

The updating module is further configured to update the computer vision algorithmic model with the model update software package.

In the above apparatus, the apparatus further includes a configuration module. The communication module is further configured to: acquire a present configuration file in the cloud server; and acquire, in a case of detecting a configuration file of an upgrade version from the cloud server, the configuration file of the upgrade version in the cloud server.

The updating module is further configured to update the present configuration file as the configuration file of the upgrade version.

In the above apparatus, the apparatus further includes a storage module configured to store the analysis processing result.

The communication module is specifically configured to synchronize, in a case where the cloud server is converted from the fault state into a normal state, the analysis processing result to the cloud server.

The embodiments of the present disclosure provide an edge device, which includes: a central processor, a graphics processor, a memory and a communication bus.

The communication bus is configured to implement connection and communication among the central processor, the graphics processor and the memory.

The central processor and the graphics processor are configured to execute one or more programs stored in the memory, to implement the above edge computing-based control method.

The embodiments of the present disclosure provide a computer-readable storage medium, which stores one or more programs, wherein the one or more programs may be executed by one or more processors, to implement the above edge computing-based control method.

The embodiments of the present disclosure provide the edge computing-based control method and apparatus, the edge device and the storage medium. The method includes that: an analysis processing tool for implementing image analysis processing in a cloud server is acquired; in a case where the cloud server is in a fault state, image analysis processing is performed on a to-be-processed image with the analysis processing tool to obtain an analysis processing result; and the analysis processing result is synchronized to the cloud server. According to the technical solutions provided by the embodiments of the present disclosure, by acquiring the image analysis tool from the cloud server through the edge device, and then performing the image analysis processing with the image analysis tool, the image analysis service can be normally provided when the cloud server is in fault.

### BRIEF DESCRIPTION OF THE DRAWINGS

FIG. 1 is a flowchart schematic diagram of an edge computing-based control method provided by an embodiment of the present disclosure.

FIG. 2 is a schematic diagram of an exemplary real-time video processing system provided by an embodiment of the present disclosure.

FIG. 3 is a structural schematic diagram of an edge computing-based control apparatus provided by an embodiment of the present disclosure.

FIG. 4 is a structural schematic diagram of an edge device provided by an embodiment of the present disclosure.

### DETAILED DESCRIPTION

A clear and complete description on the technical solutions in the embodiments of the present disclosure will be given below, in combination with the accompanying drawings in the embodiments of the present disclosure.

The embodiments of the present disclosure provide an edge computing-based control method. The executive body may be an edge device. For example, the edge computing-based control method may be executed by a terminal device or a server or other electronic devices. The terminal device may be User Equipment (UE), a mobile device, a user terminal, a terminal, a cell phone, a cordless phone, a Personal Digital Assistant (PDA), a handheld device, a computing device, a vehicle-mounted device, a wearable device, etc. In some possible implementation modes, the edge computing-based control method may be implemented by enabling a processor to call a computer-readable instruction stored in a memory.

It is to be noted that, in the embodiments of the present disclosure, the edge device for implementing the edge computing-based control method is included in a real-time video processing system. The real-time video processing system may further include a cloud server and other devices, which is not limited in the embodiments of the present disclosure.

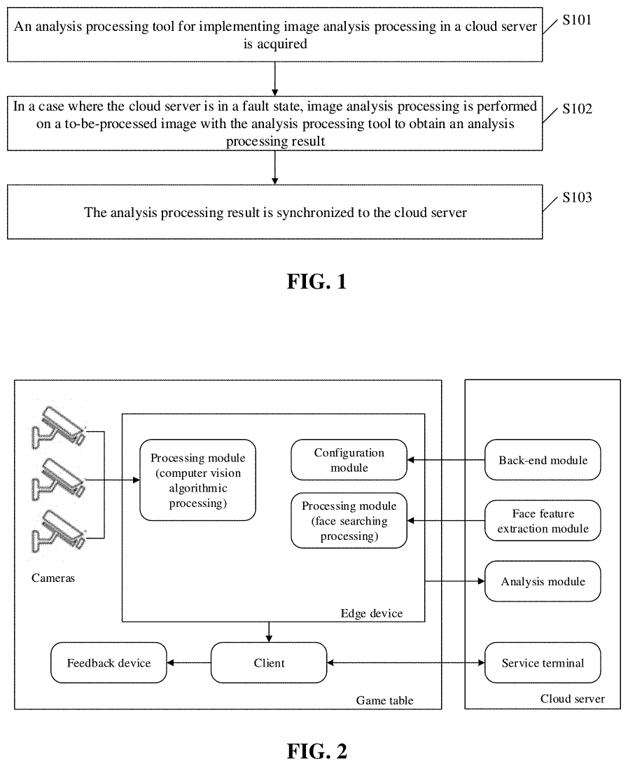

FIG. 1 is a flowchart schematic diagram of an edge computing-based control method provided by an embodiment of the present disclosure. As shown in FIG. 1, in the embodiment of the present disclosure, the edge computing-based control method may mainly include the following steps.

In S101, an analysis processing tool for implementing image analysis processing in a cloud server is acquired.

In the embodiment of the present disclosure, the edge device may acquire the analysis processing tool for implementing the image analysis processing in the cloud server.

It is to be understood that, in the embodiment of the present disclosure, the edge device needs to independently implement the image analysis processing, to solve the problem that the image analysis service cannot be completely provided when the cloud server is in a fault state in the prior art. Hence, the edge device needs to acquire the analysis processing tool in the cloud server.

Specifically, in the embodiment of the present disclosure, the analysis processing tool may include a feature information library and a computer vision algorithmic model. As the feature information library and the computer vision algorithmic model are stored in the cloud server, in order to implement the image analysis processing of the edge device, the edge device needs to acquire the feature information library and the computer vision algorithmic model in the cloud server. Certainly, the analysis processing tool may further include other models for implementing the image analysis processing, and the like, which is not limited by the embodiment of the present disclosure.

It is to be noted that, in the embodiment of the present disclosure, the edge device may perform communication interaction with the cloud server. As a database synchronization module is deployed in the cloud server, the cloud server may synchronize the feature information library to the edge device, and thus the edge device may acquire the feature information library. In this way, the edge device may also use the feature information library to implement a feature search service. The feature information library may include various types of feature information on people and objects, as well as corresponding associated information, which is not limited by the embodiment of the present disclosure.

It is to be noted that, in the embodiment of the present disclosure, after acquiring the analysis processing tool for implementing the image analysis processing in the cloud server, the edge device may further execute the following steps: in a case where the cloud server obtains feature update information, the feature update information is acquired from the cloud server; and the feature information library is updated with the feature update information.

It is to be noted that, in the embodiment of the present disclosure, the feature information library includes face feature information and associated identity information, and the cloud server may continuously perform face feature extraction on an image of a person entering a specific scenario. Hence, after the edge device acquires the feature information library, after obtaining face feature information of a new person entering the scenario, the cloud server may take identity information of the new person and corresponding face feature information as feature update information, and continuously transmits the feature update information to the edge device, such that the edge device may update the feature information library.

It is to be noted that, in the embodiment of the present disclosure, in a case where the cloud server is in a fault state, the cloud server cannot extract the face feature information of the person newly entering the specific scenario, and thus cannot synchronize the identity information of the new person and the corresponding face feature information to the edge device by this time. In view of this, after restored to a normal state, the cloud server may acquire the identity information of the new person and the corresponding face feature information in the fault state, and provide them to the cloud server.

It is to be noted that, in the embodiment of the present disclosure, the analysis processing tool includes the computer vision algorithmic model; and after the analysis processing tool for implementing the image analysis processing in the cloud server is acquired, the edge device may further execute the following steps: in a case where the cloud server generates a model update software package, the model update software package is acquired from the cloud server; and the computer vision algorithmic model is updated with the model update software package.

It is to be understood that, in the embodiment of the present disclosure, the edge device relies on the computer vision algorithmic model to operate a computer vision algorithm. As the change frequency of the algorithmic model is not high, the cloud server may package the algorithmic model into the software package to be deployed to the edge device, and thus the edge device may acquire the computer vision algorithmic model. If there is a need to update the computer vision algorithmic model, the model update software package is deployed to the edge device through the cloud server, and thus the edge device acquires the model update software package and updates the computer vision algorithmic model. As the edge device acquires the computer vision algorithmic model, the operation of the vision algorithm of the edge device is not affected even if the cloud server is in fault.

In S102, in a case where the cloud server is in a fault state, image analysis processing is performed on a to-be-processed image with the analysis processing tool to obtain an analysis processing result.

In the embodiment of the present disclosure, after the edge device acquires the analysis processing tool for implementing the image analysis processing in the cloud server, in the case where the cloud server is in the fault state, the image analysis processing may be performed on the to-be-processed image with the analysis processing tool to obtain the analysis processing result.

It is to be noted that, in the embodiment of the present disclosure, the edge device may perform communication interaction with at least one camera. The camera may acquire an image in the specific scenario, for example, an image around some game table, to serve as the to-be-processed image, thereby transmitting the to-be-processed image to the edge device for the image analysis processing. The to-be-processed image may be one or more images, which is not limited in the embodiment of the present application.

Specifically, in the embodiment of the present disclosure, the analysis processing tool includes the computer vision algorithmic model, and the operation that the edge device performs the image analysis processing on the to-be-processed image with the analysis processing tool to obtain the analysis processing result includes that: feature information extraction is performed on a target object in the to-be-processed image with the computer vision algorithmic model to obtain first feature information; and the analysis processing result is determined based on the first feature information.

It is to be noted that, in the embodiment of the present disclosure, the target object may be any person or object in the to-be-processed image. The specific target object is not limited by the embodiment of the present disclosure.

Specifically, in the embodiment of the present disclosure, the first feature information may be a first face feature, the analysis processing tool may further include the feature information library, and the operation that the edge device determines the analysis processing result based on the first feature information includes that: a second face feature matching with the first face feature is searched from the feature information library; and information associated with the second face feature in the feature information library is determined as the analysis processing result.

It is to be noted that, in the embodiment of the present disclosure, the computer vision algorithmic model may include multiple models for implementing different functions, for example, including a face feature extraction model, thereby extracting a face feature of a special person in the to-be-processed image. In addition, the computer vision algorithmic model may further include models for extracting features of actions as well as features of gestures, articles and the like; and correspondingly, the analysis processing result not only may include identity information of the person, but also may further include an action associated with the person, a type and quantity of the article, etc. The specific computer vision algorithmic model and analysis processing result are not limited by the embodiment of the present disclosure.

It is to be noted that, in the embodiment of the present disclosure, the edge device may further execute the following steps: a present configuration file in the cloud server is acquired; and in a case where a configuration file of an upgrade version is detected from the cloud server, the present configuration file is updated to the configuration file of the upgrade version.

It is to be noted that, in the embodiment of the present disclosure, the present configuration file may include a camera configuration file. After acquiring the camera configuration file, the edge device may perform relevant configuration on the camera for acquiring the to-be-processed image. Besides, a client and the like may further perform communication interaction with the edge device, and the edge device may perform the configuration with a corresponding file in the configuration file. In addition, the present configuration file may also include scenario information corresponding to the to-be-processed image. For example, the to-be-processed image is a gaming scenario on a special game table; and correspondingly, the present configuration file may include information on a type, region division and the like of the game table, and the information may serve as a basis for logical analysis of the service. The specific present configuration file may be set according to an actual application scenario and an actual demand, which is not limited by the embodiment of the present disclosure.

It is to be noted that, in the embodiment of the present disclosure, the edge device may perform communication interaction with the cloud server, so the edge device may directly acquire the present configuration file from the cloud server. The cloud server includes a back-end module. The configuration file is uniformly managed by the back-end module of the cloud server. The edge device communicates with the back-end module of the cloud server, and thus may acquire the present configuration file from the back-end module.

It is to be understood that, in the embodiment of the present disclosure, the edge device may communicate with the cloud server, and thus may detect the version of the configuration file in the cloud server. If the version of the configuration file in the cloud server is higher than that of the acquired configuration file, the configuration file of the upgrade version may be locally downloaded to upgrade the configuration file. Correspondingly, when the edge device performs system operation configuration subsequently, the configuration file used is the configuration file of the upgrade version.

It is to be noted that, in the embodiment of the present disclosure, in a case where the cloud server is in a normal state, the cloud server may perform the image analysis processing on the to-be-processed image with a local analysis processing tool to obtain the analysis processing result.

In S103, the analysis processing result is synchronized to the cloud server.

In the embodiment of the present disclosure, the edge device may synchronize the analysis processing result to the cloud server after obtaining the analysis processing result.

It is to be noted that, in the embodiment of the present disclosure, after implementing the image analysis processing on the to-be-processed image, the edge device may synchronize the image analysis processing to the cloud server; and after obtaining the analysis processing result, the cloud server may further perform other processing based on the analysis processing result.

Specifically, in the embodiment of the present disclosure, the operation that the edge device synchronizes the analysis processing result to the cloud server includes that: the analysis processing result is stored; and in a case where the cloud server is converted from the fault state into a normal state, the analysis processing result is synchronized to the cloud server.

It is to be understood that, in the embodiment of the present disclosure, the edge device may cache the analysis processing result first in the case where the cloud server is in the fault state. In this way, in the case where the cloud server is restored to the normal state, the edge device may further continuously send the analysis processing result to the cloud server to be processed by the cloud server.

FIG. 2 is a schematic diagram of an exemplary real-time video processing system provided by an embodiment of the present disclosure. As shown in FIG. 2, the real-time video processing system not only includes the edge device and the cloud server described above, but also includes three cameras, a feedback device and a client. The edge device, the three cameras, the feedback device and the client are all arranged on the same game table. The edge device may be provided with two processing modules and a configuration module. The cloud server may be provided with a back-end module, a face feature extraction module, an analysis module and a service terminal. The processing module (computer vision algorithmic processing) of the edge device may interact with a camera to obtain a to-be-processed image for the computer vision algorithmic processing, such as face feature extraction and action feature extraction. For the edge device and the cloud server, the configuration module interacts with the back-end module to obtain a configuration file, a computer vision algorithmic model and the like; and the processing module (face searching processing) may interact with the face feature extraction module to obtain a face feature library and a real-time update face feature, thereby further performing face searching according to the face feature extracted from the to-be-processed image. The edge device may send an analysis processing result to the analysis module for further analysis processing. In addition, the edge device and the service terminal of the cloud server may further perform information interaction with the client, and the client may perform information interaction with the feedback device.

It is to be noted that, in the embodiment of the present disclosure, the above FIG. 2 is merely the exemplary real-time video processing system provided by the embodiment of the present disclosure, and the modules respectively included in the edge device and the cloud server are merely exemplary functional modules. In addition, other devices in the system may also be added or deleted according to the actual application scenario and demand, which is not limited by the embodiment of the present disclosure.

It is to be understood that, in the embodiment of the present disclosure, the image analysis processing is at the edge side, i.e., the image analysis processing is executed by the edge device, such that when the cloud server is in fault, the normal operation of the image analysis service can be ensured, and the feature information library can be automatically synchronized to the edge device through the cloud server, and thus the feature matching can be supported at the edge side to acquire the associated information. In addition, the configuration file is synchronously cached in the edge device, ensuring the automatic operation of the edge device.

The embodiment of the present disclosure provides the edge computing-based control method. The method is be applied to the edge device, and includes that: an analysis processing tool for implementing image analysis processing in a cloud server is acquired; in a case where the cloud server is in a fault state, image analysis processing is performed on a to-be-processed image with the analysis processing tool to obtain an analysis processing result; and the analysis processing result is synchronized to the cloud server. According to the edge computing-based control method provided by the embodiment of the present disclosure, by acquiring the image analysis tool from the cloud server through the edge device, and then performing the image analysis processing with the image analysis tool, the image analysis service can be normally provided when the cloud server is in fault.

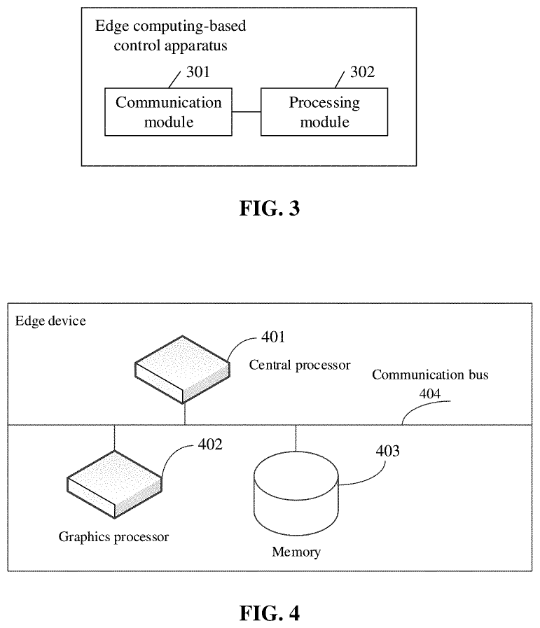

The embodiments of the present disclosure further provide an edge computing-based control apparatus, applied to an edge device. FIG. 3 is a structural schematic diagram of an edge computing-based control apparatus provided by an embodiment of the present disclosure. As shown in FIG. 3, the control apparatus includes a communication module 301 and a processing module 302.

The communication module 301 is configured to acquire an analysis processing tool for implementing image analysis processing in a cloud server.

The processing module 302 is configured to perform, in a case where the cloud server is in a fault state, image analysis processing on a to-be-processed image with the analysis processing tool to obtain an analysis processing result.

The communication module 301 is further configured to synchronize the analysis processing result to the cloud server.

In an embodiment of the present disclosure, the analysis processing tool includes a computer vision algorithmic model, and the processing module 302 is specifically configured to: extract feature information of a target object in the to-be-processed image with the computer vision algorithmic model to obtain first feature information; and determine the analysis processing result based on the first feature information.

In an embodiment of the present disclosure, the first feature information is a first face feature, the analysis processing tool further includes a feature information library, and the processing module 302 is specifically configured to: search a second face feature matching with the first face feature from the feature information library; and determine information associated with the second face feature in the feature information library as the analysis processing result.

In an embodiment of the present disclosure, the apparatus further includes an updating module (not shown), and the communication module 301 is further configured to acquire, in a case where the cloud server obtains feature update information, the feature update information from the cloud server.

The updating module is further configured to update the feature information library with the feature update information.

In an embodiment of the present disclosure, the communication module 301 is further configured to acquire, in a case where the cloud server generates a model update software package, the model update software package from the cloud server.

The updating module is further configured to update the computer vision algorithmic model with the model update software package.

In an embodiment of the present disclosure, the apparatus further includes a configuration module (not shown); and the communication module 301 is further configured to: acquire a present configuration file in the cloud server; and acquire, in a case of detecting a configuration file of an upgrade version from the cloud server, the configuration file of the upgrade version in the cloud server.

The updating module is further configured to update the present configuration file to the configuration file of the upgrade version.

In an embodiment of the present disclosure, the apparatus further includes a storage module (not shown) configured to store the analysis processing result in the case where the cloud server is in the fault state.

The communication module 301 is specifically configured to synchronize, in a case where the cloud server is converted from the fault state into a normal state, the analysis processing result to the cloud server.

It is to be understood that, in the embodiment of the present disclosure, the edge device caches the analysis processing result first in the case where the cloud server is in the fault state. In this way, in the case where the cloud server is restored to the normal state, the edge device may provide the analysis processing result to the cloud server again, and the cloud server may execute other special processing with the analysis processing result to meet corresponding requirements.

The embodiment of the present disclosure provides the edge computing-based control apparatus, applied to the edge device. The control apparatus acquires an analysis processing tool for implementing image analysis processing in a cloud server; performs, in a case where the cloud server is in a fault state, image analysis processing on a to-be-processed image with the analysis processing tool to obtain an analysis processing result; and synchronizes the analysis processing result to the cloud server. The control apparatus provided by the embodiment of the present disclosure and applied to the edge device acquires the image analysis tool from the cloud server, and performs the image analysis processing with the image analysis tool, and thus can provide the image analysis service normally when the cloud server is in fault.

The embodiments of the present disclosure further provide an edge device. FIG. 4 is a structural schematic diagram of an edge device provided by an embodiment of the present disclosure. As shown in FIG. 4, the edge device includes a central processor 401, a graphics processor 402, a memory 403 and a communication bus 404.

The communication bus 404 is configured to implement connection and communication among the central processor 401, the graphics processor 402 and the memory 403.

The central processor 401 and the graphics processor 402 are configured to execute one or more programs stored in the memory 403, to implement the above edge computing-based control method.

The embodiments of the present disclosure provide a computer-readable storage medium, which stores one or more programs; and the one or more programs may be executed by one or more processors to implement the above edge computing-based control method. The computer-readable storage may be a volatile memory such as a Random-Access Memory (RAM), or a non-volatile memory such as a Read-Only Memory (ROM), a flash memory, a Hard Disk Drive (HDD) or a Solid-State Drive (SSD), or may be a device including any one or combination of the above memories, such as a mobile phone, a computer, a tablet device and a PDA.

Those skilled in the art should understand that the embodiments of the present disclosure can provide a method, a system or a computer program product. Thus, forms of hardware embodiments, software embodiments or embodiments integrating software and hardware can be adopted in the present disclosure. Moreover, a form of the computer program product implemented on one or more computer available storage media (including, but not limited to, a disk memory, an optical memory and the like) containing computer available program codes can be adopted in the present disclosure.

The present disclosure is described with reference to flowcharts and/or block diagrams of the method, the device (system) and the computer program product according to the embodiments of the present disclosure. It should be understood that each flow and/or block in the flowcharts and/or the block diagrams and a combination of the flows and/or the blocks in the flowcharts and/or the block diagrams can be realized by computer program instructions. These computer program instructions can be provided for a general computer, a dedicated computer, an embedded processor or processors of other programmable data processing devices to generate a machine, so that an apparatus for realizing functions assigned in one or more flows of the flowcharts and/or one or more blocks of the block diagrams is generated via instructions executed by the computers or the processors of the other programmable data processing devices.

These computer program instructions can also be stored in a computer-readable memory capable of guiding the computers or the other programmable data processing devices to work in a specific mode, so that a manufactured product including an instruction apparatus is generated via the instructions stored in the computer-readable memory, and the instruction apparatus realizes the functions assigned in one or more flows of the flowcharts and/or one or more blocks of the block diagrams.

These computer program instructions can also be loaded to the computers or the other programmable data processing devices, so that processing realized by the computers is generated by executing a series of operation steps on the computers or the other programmable devices, and therefore the instructions executed on the computers or the other programmable devices provide a step of realizing the functions assigned in one or more flows of the flowcharts and/or one or more blocks of the block diagrams.

The above are merely preferred embodiments of the present disclosure, rather than a limit to the protection scope of the present disclosure.

1. An edge computing-based control method, applied to an edge device, and comprising:
acquiring an analysis processing tool for implementing image analysis processing in a cloud server;
performing, in a case where the cloud server is in a fault state, image analysis processing on a to-be-processed image with the analysis processing tool to obtain an analysis processing result; and
synchronizing the analysis processing result to the cloud server.

2. The method of claim 1, wherein the analysis processing tool comprises a computer vision algorithmic model, and performing the image analysis processing on the to-be-processed image with the analysis processing tool to obtain the analysis processing result comprises:
performing feature information extraction on a target object in the to-be-processed image with the computer vision algorithmic model to obtain first feature information; and
determining the analysis processing result based on the first feature information.

3. The method of claim 2, wherein the first feature information is a first face feature, the analysis processing tool further comprises a feature information library, and determining the analysis processing result based on the first feature information comprises:
searching a second face feature matching with the first face feature from the feature information library; and
determining information associated with the second face feature in the feature information library as the analysis processing result.

4. The method of claim 3, after acquiring the analysis processing tool for implementing the image analysis processing in the cloud server, further comprising:
acquiring, in a case where the cloud server obtains feature update information, the feature update information from the cloud server; and
updating the feature information library with the feature update information.

5. The method of claim 2, after acquiring the analysis processing tool for implementing the image analysis processing in the cloud server, further comprising:
acquiring, in a case where the cloud server generates a model update software package, the model update software package from the cloud server; and
updating the computer vision algorithmic model with the model update software package.

6. The method of claim 1, further comprising:
acquiring a present configuration file in the cloud server;
acquiring, in a case of detecting a configuration file of an upgrade version from the cloud server, the configuration file of the upgrade version in the cloud server; and
updating the present configuration file to the configuration file of the upgrade version.

7. The method of claim 1, wherein synchronizing the analysis processing result to the cloud server comprises:
storing the analysis processing result; and
synchronizing, in a case where the cloud server is converted from the fault state into a normal state, the analysis processing result to the cloud server.

8. An edge device, comprising: a central processor, a graphics processor, a memory and a communication bus, wherein
the communication bus is configured to implement connection and communication among the central processor, the graphics processor and the memory; and
the central processor and the graphics processor are configured to execute one or more programs stored in the memory, to implement following steps:
acquiring an analysis processing tool for implementing image analysis processing in a cloud server;
performing, in a case where the cloud server is in a fault state, image analysis processing on a to-be-processed image with the analysis processing tool to obtain an analysis processing result; and
synchronizing the analysis processing result to the cloud server.

9. The edge device of claim 8, wherein the analysis processing tool comprises a computer vision algorithmic model, and for the step of performing the image analysis processing on the to-be-processed image with the analysis processing tool to obtain the analysis processing result, the central processor and the graphics processor are configured to implement following steps:
performing feature information extraction on a target object in the to-be-processed image with the computer vision algorithmic model to obtain first feature information; and
determining the analysis processing result based on the first feature information.

10. The edge device of claim 9, wherein the first feature information is a first face feature, the analysis processing tool further comprises a feature information library, and for the step of determining the analysis processing result based on the first feature information, the central processor and the graphics processor are configured to implement following steps:
searching a second face feature matching with the first face feature from the feature information library; and
determining information associated with the second face feature in the feature information library as the analysis processing result.

11. The edge device of claim 10, after acquiring the analysis processing tool for implementing the image analysis processing in the cloud server, the central processor and the graphics processor are further configured to implement following steps:
acquiring, in a case where the cloud server obtains feature update information, the feature update information from the cloud server; and
updating the feature information library with the feature update information.

12. The edge device of claim 9, after acquiring the analysis processing tool for implementing the image analysis processing in the cloud server, the central processor and the graphics processor are further configured to implement following steps:
acquiring, in a case where the cloud server generates a model update software package, the model update software package from the cloud server; and
updating the computer vision algorithmic model with the model update software package.

13. The edge device of claim 8, the central processor and the graphics processor are further configured to implement following steps:
acquiring a present configuration file in the cloud server;
acquiring, in a case of detecting a configuration file of an upgrade version from the cloud server, the configuration file of the upgrade version in the cloud server; and
updating the present configuration file to the configuration file of the upgrade version.

14. The edge device of claim 8, wherein for the step of synchronizing the analysis processing result to the cloud server, the central processor and the graphics processor are further configured to implement following steps:
storing the analysis processing result; and
synchronizing, in a case where the cloud server is converted from the fault state into a normal state, the analysis processing result to the cloud server.

15. A non-volatile computer-readable storage medium, storing one or more programs, wherein the one or more programs are executable by one or more processors to:
acquire an analysis processing tool for implementing image analysis processing in a cloud server;
perform, in a case where the cloud server is in a fault state, image analysis processing on a to-be-processed image with the analysis processing tool to obtain an analysis processing result; and
synchronize the analysis processing result to the cloud server.
